(19) United States
(12) Patent Application Publication
(10) Pub. No.: US 2015/0142630 A1
(43) Pub. Date: May 21, 2015

(54) RISK SCENARIO GENERATION

(71) Applicant: International Business Machines Corporation, Armonk, NY (US)

(72) Inventors: Mourad Benouarets, Burlington (CA); James Hendrick DeGraaf, Mississauga (CA); Igor Patlashenko, Richmond Hill (CA); Serguei Vassilovski, Toronto (CA); Lior Velichover, Vaughan (CA)

(73) Assignee: International Business Machines Corporation

(21) Appl. No.: 14/308,316

(22) Filed: Jun. 18, 2014

Related U.S. Application Data
(63) Continuation of application No. 14/081,946, filed on Nov. 15, 2013.

(51) Int. Cl. G06Q 40/00

(52) U.S. Cl. CPC G06Q 40/00
USPC 705/35

(57) ABSTRACT

Techniques are described for processing scenario sets. In one example, a method comprises determining, by at least one computer processor, a computation graph, wherein the computation graph comprises at least one of: a random increment generator, a transformation matrix, a group of scenario indices, and calibrated model parameters; and distributing, by the at least one computer processor, the computation graph to one or more computation nodes, wherein each computation node of the one or more computation nodes is configured to generate scenario data specific to the respective computation node based on the computation graph, and wherein each computation node of the one or more computation nodes is configured to use the respective scenario data to measure risk in a financial system.

This application is a Continuation of U.S. application Ser. No. 14/081,946, filed Nov. 15, 2013 entitled RISK SCENARIO GENERATION, the entire content of which is incorporated herein by reference.

### TECHNICAL FIELD

The disclosure relates to risk scenario generation for computing systems.

### BACKGROUND

The simulation approach to portfolio risk management involves identifying risk factors that influence the prices of financial instruments, creating a scenario set model based on those risk factors, calculating the value of each financial instrument using pricing functions under each scenario, and constructing an empirical distribution of portfolio values by summing instrument values. Risk factors could be anything that affects the future value of a portfolio, including market returns, interest rates, inflation, foreign currency exchange rates, industrial production, and success of competitors, among other things. Although the number of risk factors in the scenario set is typically much smaller than the number of instruments in the portfolio, the resulting scenario set can nevertheless be quite large if the number of simulation time steps and/or the number of scenarios is large.

Generating these scenario sets can be very helpful in managing a portfolio. A portfolio manager can look at these scenario sets and recommend a course of action for a customer based on different approaches that the customer may want to take, such as a low-risk/low-reward approach where they are relatively safe in their investment strategy or a high-risk/high-reward approach where they have the chance to make a large amount of money while also taking the risk to lose a large amount of money. Differing strategies may also cause a portfolio manager to only consider certain scenarios in a scenario set while ignoring others, meaning that only a portion of the large scenario set described above may be needed.

### SUMMARY

In one example, the disclosure is directed to a method that includes determining, by at least one computer processor, a computation graph, wherein the computation graph comprises at least one of: a random increment generator, a transformation matrix, a group of scenario indices, and calibrated model parameters. The at least one computer processor may distribute the computation graph to one or more computation nodes, wherein each computation node of the one or more computation nodes is configured to generate scenario data specific to the respective computation node based on the computation graph, and wherein each computation node of the one or more computation nodes is configured to use the respective scenario data to measure risk in a financial system.

In one example, the disclosure is directed to a system to distribute and generate scenario sets. In this system, at least one computer processor determines a computation graph, wherein the computation graph comprises at least one of: a random increment generator, a transformation matrix, a group of scenario indices, and calibrated model parameters. The at least one computer processor may then distribute the computation graph to one or more computation nodes, wherein each computation node of the one or more computation nodes is configured to generate scenario data specific to the respective, computation node based on the computation graph, and wherein each computation node of the one or more computation nodes is configured to use the respective scenario data to measure risk in a financial system.

In one example, the disclosure is directed to a computer-readable medium containing instructions. The instructions cause a programmable processor to determine a computation graph, wherein the computation graph comprises at least one of: a random increment generator, a transformation matrix, a group of scenario indices, and calibrated model parameters. The programmable processor may then instruct the distribution the computation graph to one or more computation nodes, wherein each computation node of the one or more computation nodes is configured to generate scenario data specific to the respective computation node based on the computation graph, and wherein each computation node of the one or more computation nodes is configured to use the respective scenario data to measure risk in a financial system.

In one example, the disclosure is directed to a method that includes receiving, by at least one computer processor and from a central computing device, a computation graph, wherein the computation graph comprises at least one of: a random increment generator, a transformation matrix, a group of scenario indices, and calibrated model parameters and is determined by the central computing device. The at least one computer processor may then generate scenario data based on the computation graph to measure risk in a financial system.

In one example, the disclosure is directed to a computer-readable storage medium containing instructions. The instructions cause at least one programmable processor to receive, from a central computing device, a computation graph, wherein the computation graph comprises at least one of: a random increment generator, a transformation matrix, a group of scenario indices, and calibrated model parameters and is determined by the central computing device; and generate scenario data based on the computation graph to measure risk in a financial system.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example scenario generation system, in accordance with one or more aspects of the present disclosure.

FIG. 2 is a block diagram illustrating one example of the central computing device shown in FIG. 1, in accordance with one or more aspects of the present disclosure.

FIG. 3 is a block diagram illustrating one example of a communication between the central computing device and one of the computation nodes shown in FIG. 1, in accordance with one or more aspects of the present disclosure.

FIG. 4 is a block diagram illustrating an example of a generation of a scenario set, in accordance with one or more aspects of the present disclosure.

FIG. 5 is a block diagram illustrating an example of a transformation act in the generation of the scenario set shown in FIG. 4, in accordance with one or more aspects of the present disclosure.

FIG. 6 is a flow diagram illustrating an example process to generate scenario data, in accordance with one or more aspects of the present disclosure.

FIG. 7 is a flow diagram illustrating an example process to calibrate and generate scenario data, in accordance with one or more aspects of the present disclosure.

### DETAILED DESCRIPTION

In general, the disclosure is directed to scenario set generation that may be compressed at a central computing device and decompressed at one or more computation nodes. A central computing device determines a computation graph, wherein the computation graph comprises at least one of: a random increment generator, a transformation matrix, a group of scenario indices, and calibrated model parameters. The central computing device may distribute the computation graph to one or more computation nodes, wherein each computation node of the one or more computation nodes is configured to generate scenario data specific to the respective computation node based on the computation graph, and wherein each computation node of the one or more computation nodes is configured to use the respective scenario data to measure risk in a financial system.

Scenario set compression may allow for the distribution of large scenario sets to an array of simulators spread across a grid of computation nodes, focusing on the potential minimization of bandwidth and time by maximizing the use of computation node resources. One or more aspects of the present disclosure describe a scenario set compression scheme with a potentially asymptotically infinite compression ratio, coupled with a high efficiency decompression algorithm based on matrix calculations.

In some examples, a process of creating a risk factor scenario set may be partitioned into two distinct phases: a calibration or determination phase in which all data for a joint simulation of risk factor values is prepared, and a generation or distribution phase in which actual risk factor values are calculated. The calibration phase may be performed centrally on one computing device, and the resultant state may be serialized and sent to each computation node in a cluster. The size of the calibration data may be independent of the number of scenarios to be generated, and it is often a fraction of a full scenario set. The generation phase may be performed locally at each computation node. Generally, the central computing device is a computing device having greater computing power than each of the computation nodes, although, in other examples, the central computing device and the computation nodes may have substantially equal, or similar, computing power. To allow the generation phase to proceed quickly on certain nodes, the generation phase has been reformulated, in certain examples, as matrix-matrix multiplication that partially generates multiple scenarios at a time.

One aspect of the present disclosure relates to a compression algorithm where calibration data is serialized to a file, the file may be copied to multiple computation nodes, and generation takes place to produce multiple copies of the full scenario set file or various portions of the full scenario set file. That is, the method may be analogous to compressing a file before sending it multiple remote computer systems, where the compressed file is decompressed back to the original file. In various examples, the compression scheme may have an asymptotically infinite compression ratio, meaning that, from a constant-sized calibration file, a scenario set file of arbitrarily large size can be generated (e.g., an infinite number of scenarios can be generated from the same calibration file). In relation to the distribution of risk factor scenario sets, network bandwidth may be potentially decreased due to the transmission of less data and increased performance due to distribution of the generation process.

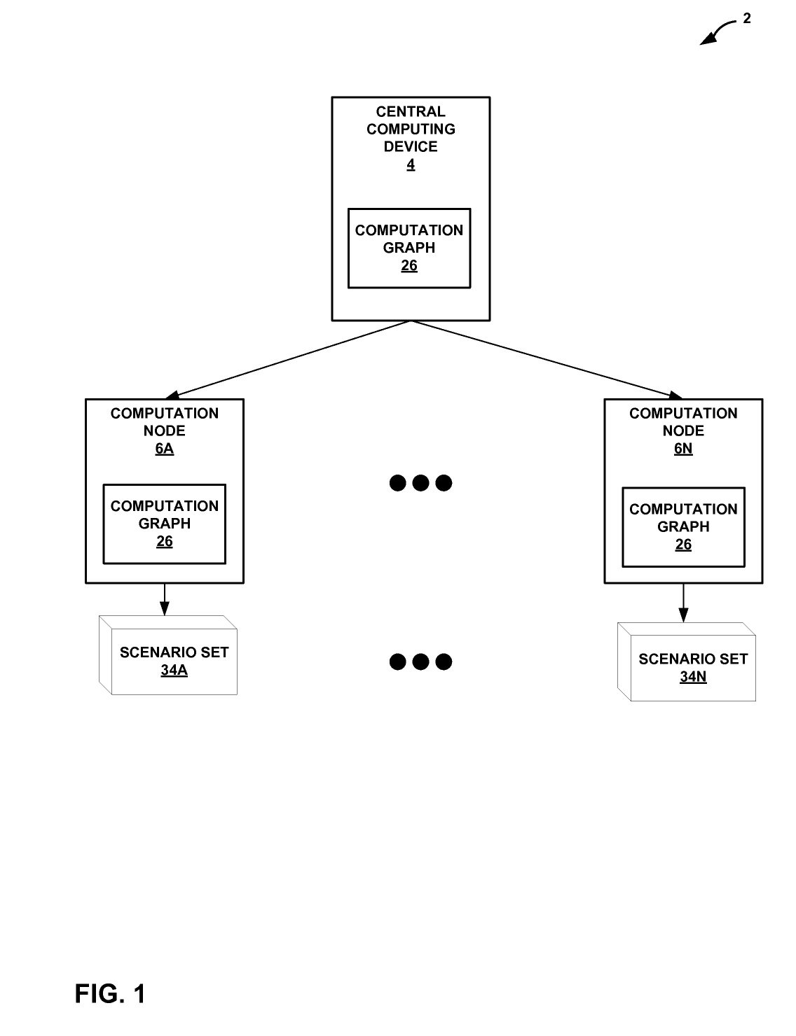

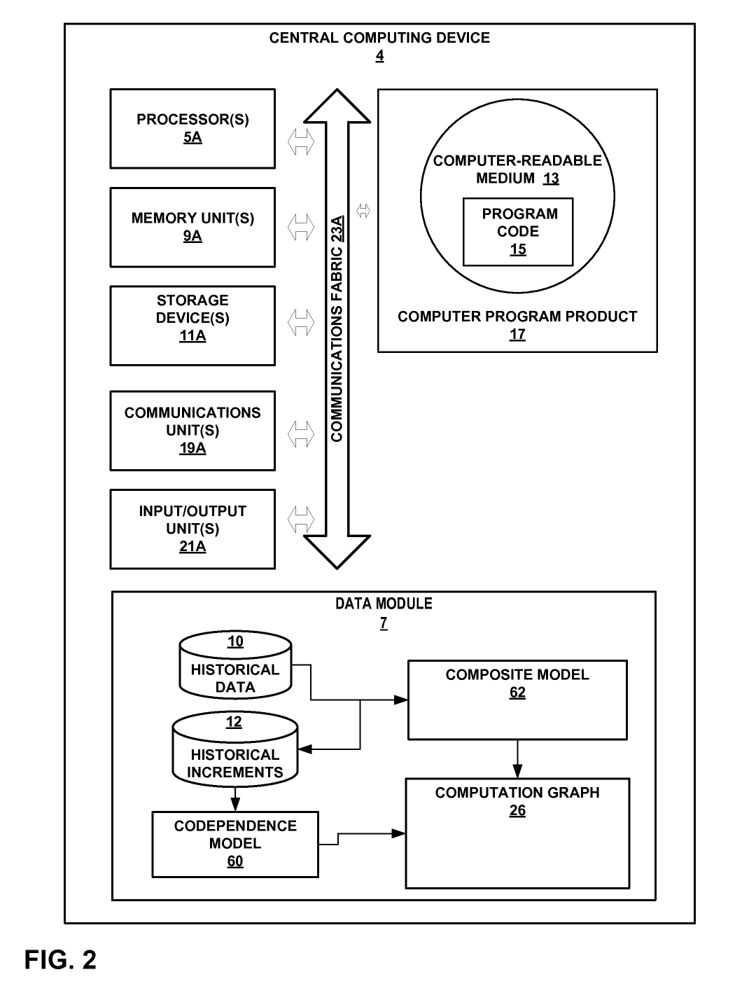

FIG. 1 is a block diagram illustrating an example of a scenario set generation system 2, in accordance with one or more aspects of the present disclosure. In this example, central computing device 4 generates a computation graph 26. After central computing device 4 generates this computation graph 26, central computing device 4 distributes the computation graph 26 to one or more computation nodes 6A-6N (collectively, computation nodes 6). Although only two computation nodes are depicted, other examples may have more than two computation nodes, while other examples may only have a singular computation node. Each of the computation nodes 6 creates a respective scenario set 34A-34N (collectively, scenario sets 34) based on the information in composite scenario 26. This process is discussed in further detail with regards to FIGS. 2-7.

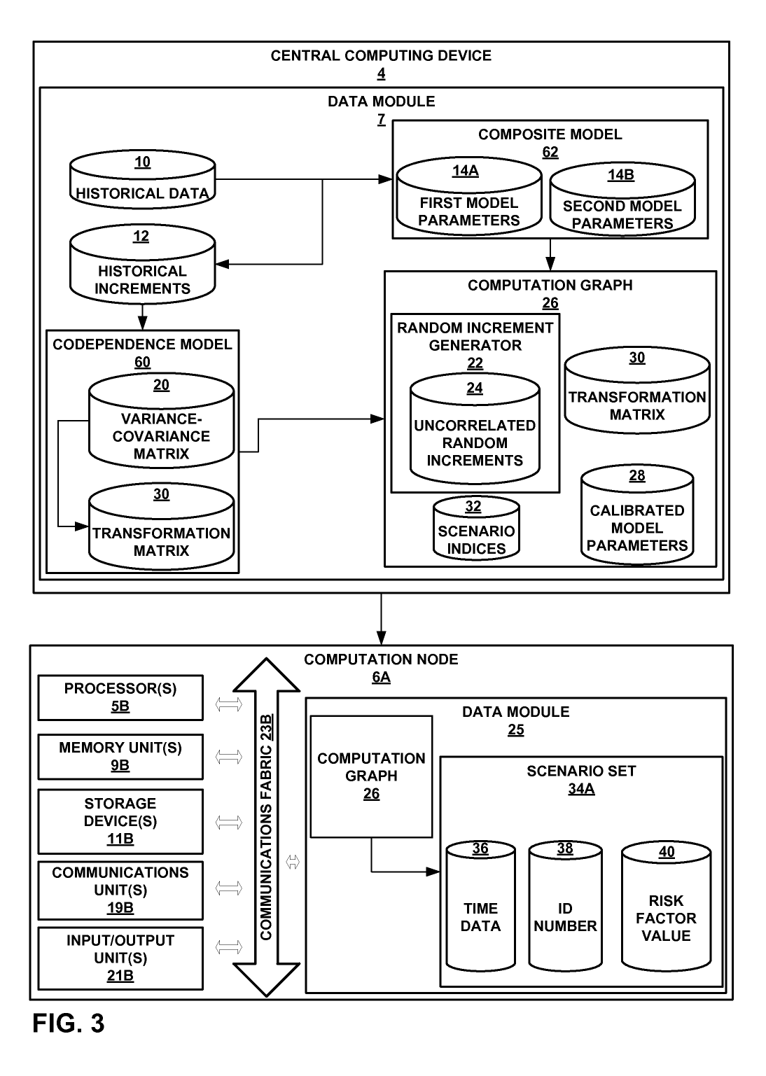

Central computing device 4 shown in FIG. 1 may comprise one or more computer processors. In other examples, central computing device 4 could also be implemented as a computing device executing program code locally, a hosted network service, or a cloud-based service. One example of central computing device 4 is discussed in further detail with regards to FIG. 2 and FIG. 3. Central computing device 4 is operable to send computation graph 26 to computation nodes 6 over any wired or wireless network such as the Internet, a private corporate intranet, or a PSTN telephonic network. These networks could be either public or private networks. Central computing device 4 may, in some instances, send the computation graph 26 to computation nodes 6 within the same overall computing system by wired transfer mechanisms.

Computation nodes 6 shown in FIG. 1 may comprise one or more computer processors. In other examples, computation nodes 6 could also be implemented as computing devices executing program code locally, users systems that are subscribing to a hosted network service or a cloud-based system, hosted network services, or cloud-based services. If computation nodes 6 are hosted network services or cloud-based services, they may be configured to further deliver the corresponding scenario set 34 to a user.

Computation graph 26 may comprise a set of data generated by central computing device 4 with instructions for the computation nodes 6 on how to create the corresponding scenario sets 34. Computation graph 26 includes, in certain examples, calibrated model parameters, a random increment generator, a transformation matrix, and scenario indices. At a high level, the scenario indices instruct computation node 6 as to what scenarios are to be generated for the computation node's operations. Once this subset of scenarios is indicated, the calibrated model parameters, the random increment generator, and the transformation matrix are used to generate that subset of scenarios. A more detailed description of computation graph 26 and its various components are discussed in further detail with regards to FIG. 3.

Scenario sets 34 are, in certain examples, three-dimensional matrixes. In these non-limiting examples, the axes of these three-dimensional matrixes are time, risk factor values wherein the risk factor value is a function of at least a previous value of the risk factor value, a time interval since the previous value of the risk factor value was realized, an increment from a codependence model, and a scenario identification number. A two-dimensional cross-section of a scenario set comprising a time and a risk factor is known as a scenario. In other words, a scenario may be a stochastic model for the joint evolution of risk factors over time.

A scenario set, then, may comprise a collection of scenarios. A more detailed depiction of scenario sets 34 and their components is discussed in further detail with regards to FIG. 3.

FIG. 2 is a block diagram illustrating one example of central computing device 4 shown in FIG. 1, in accordance with one or more aspects of the present disclosure. The risk scenario generation system may enable creation and operation of computation graphs either by incorporating this capability within a single application, or by making calls or requests to or otherwise interacting with any of a number of other modules, libraries, data access services, indexes, databases, servers, or other computing environment resources, for example. Central computing device 4 may be a workstation, server, mainframe computer, notebook or laptop computer, desktop computer, tablet, smartphone, feature phone, or other programmable data processing apparatus of any kind. Other possibilities for central computing device 4 are possible, including a computer having capabilities or formats other than or beyond those described herein.

In this illustrative example, central computing device 4 includes communications fabric 23A, which provides communications between one or more computer processors 5A, one or more memory units 9, one or more storage devices 11, one or more communications units 19, and one or more input/output (I/O) units 21. Communications fabric 23A may include a dedicated system bus, a general system bus, multiple buses arranged in hierarchical form, any other type of bus, bus network, switch fabric, or other interconnection technology. Communications fabric 23A supports transfer of data, commands, and other information between various subsystems of central computing device 4.

Computer processor 5A may be a programmable processor, such as a programmable central processing unit (CPU) configured for executing programmed instructions stored in memory unit 9A. In another illustrative example, computer processor 5A may be implemented using one or more heterogeneous processor systems in which a main processor is present with secondary processors on a single chip. In yet another illustrative example, computer processor 5A may be a symmetric multi-processor system containing multiple processors of the same type. Computer processor 5A may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, computer processor 5A may include a multi-core processor, such as a dual core or quad core processor, for example. Computer processor 5A may include multiple processing chips on one die, and/or multiple dies on one package or substrate, for example. Computer processor 5A may also include one or more levels of integrated cache memory, for example. In various examples, computer processor 5A may include one or more CPUs distributed across one or more locations.

Memory unit 9A and storage device 11A are in communication with computer processor 5A through communications fabric 23A. Memory unit 9A can include a random access semiconductor memory (RAM) for storing application data, i.e., computer program data, for processing. While memory unit 9A is depicted conceptually as a single monolithic entity in FIG. 2, in various examples, memory unit 9A may be arranged in a hierarchy of caches and in other memory devices, in a single physical location, or distributed across a plurality of physical systems in various forms. While memory unit 9A is depicted physically separated from computer processor 5A and other elements of central computing device 4, memory unit 9A may refer equivalently to any intermediate or cache memory at any location throughout central computing device 4, including cache memory proximate to or integrated with computer processor 5A or individual cores of computer processor 5A.

Storage device 11A may include one or more hard disc drives, solid state drives, flash drives, rewritable optical disc drives, magnetic tape drives, or any combination of these or other data storage media. Storage device 11A may store computer-executable instructions or computer-readable program code for an operating system, application files that include program code, data structures or data files, and any other type of data. These computer-executable instructions may be loaded from storage device 11A into memory unit 9A to be read and executed by computer processor 5A or other processors. Central computing device 4 may also include any other hardware elements capable of storing information, such as, for example and without limitation, data, program code in functional form, and/or other suitable information, either on a temporary basis and/or a permanent basis.

Storage device 11A and memory unit 9A are examples of physical, tangible, non-transitory computer-readable data storage devices. Central computing device 4 may include any of various forms of volatile memory that may require being periodically electrically refreshed to maintain data in memory, but those skilled in the art will recognize that this also constitutes an example of a physical, tangible, non-transitory computer-readable data storage device, Executable instructions are stored on a non-transitory medium when program code is loaded, stored, relayed, buffered, or cached on a non-transitory physical medium or device, including if only for only a short duration or only in a volatile memory format.

Computer processor 5A can also be suitably programmed to read, load, and execute computer-executable instructions or computer-readable program code for risk scenario generation, as described in greater detail below. This program code may be stored on memory unit 9A, storage device 11A, or elsewhere in central computing device 4. This program code may also take the form of program code 15 stored on computer-readable medium 13 that is included in computer program product 17, and may be transferred or communicated, through any of a variety of local or remote means, from computer program product 17 to central computing device 4 to be enabled to be executed by computer processor 5A, as further explained below.

Communications unit 19A, in this example, provides for communications with other computing or communications systems or devices. Communications unit 19A may provide communications through the use of physical and/or wireless communications links. Communications unit 19A may include a network interface card for interfacing with a network, an Ethernet adapter, a Token Ring adapter, a modem for connecting to a transmission system such as a telephone line, or any other type of communication interface. Communications unit 19A can be used for operationally connecting many types of peripheral computing devices to central computing device 4, such as printers, bus adapters, and other computers. Communications unit 19A may be implemented as an expansion card or be built into a motherboard, for example.

The input/output unit 21A can support devices suited for input and output of data with other devices that may be connected to central computing device 4, such as keyboard, a mouse or, other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 21A may also include any type of interface for video output in any type of video output protocol and any type of monitor or other video display technology, in various examples. It will be understood that some of these examples may overlap with each other, or with example components of communications unit 19A or storage device 11A. Input/output unit 21A may also include appropriate device drivers for any type of external device, or such device drivers may reside in the operating system or elsewhere on central computing device 4 as appropriate.

Input/output unit 21A may include a drive, socket, or outlet for receiving computer program product 17, which includes a computer-readable medium 13 having computer program code 15 stored thereon. For example, computer program product 17 may be a CD-ROM, a DVD-ROM, a Blu-Ray disc, a magnetic disc, a USB stick, a flash drive, or an external hard disc drive, as illustrative examples, or any other suitable data storage technology. Computer program code 15 may include a risk scenario generation application, as described below.

Computer-readable medium 13 may include any type of optical, magnetic, or other physical medium that physically encodes program code 15 as a binary series of different physical states in each unit of memory that, when read by central computing device 4, induces a physical signal that is read by a programmable processor, such as computer processor 5A that corresponds to the physical states of the basic data storage elements of storage medium 13, and that induces corresponding changes in the physical state of a programmable processor, such as computer processor 5A. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of a programmable processor, such as computer processor 5A, thereby physically causing the programmable processor, such as computer processor 5A, to generate physical outputs that correspond to the computer-executable instructions, in a way that modifies central computing device 4 into a new physical state and causes central computing device 4 to physically assume new capabilities that it did not have until its physical state was changed by loading the executable instructions included in program code 15.

In some illustrative examples, program code 15 may be downloaded or otherwise accessed over a network to storage device 11A from another device or computer system, such as a server, for use within central computing device 4. Program code 15 that includes computer-executable instructions may be communicated or transferred to central computing device 4 from computer-readable medium 13 through a hard-tine or wireless communications link to communications unit 19A and/or through a connection to input/output unit 21A. Computer-readable medium 13 that includes program code 15 may be located at a separate or remote location from central computing device 4, and may be located anywhere, including at any remote geographical location anywhere in the world, and may relay program code 15 to central computing device 4 over any type of one or more communication links, such as the Internet and/or other packet data networks. The program code 15 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 15 may be transmitted from a source computer-readable medium 13 over non-tangible media, such as communications links or wireless transmissions containing the program code 15. Program code 15 may be more or less temporarily or durably stored on any number of intermediate tangible, physical computer-readable devices and media, such as any number of physical buffers, caches, main memory, or data storage components of servers, gateways, network nodes, mobility management entities, or other network assets, on route from its original source medium to central computing device 4.

Central computing device 4 may also contain data module 7. Data module 7 may contain a variety of data stores or data producing devices, including historical data 10, composite model 62, historical increments 12, codependence model 60, and computation graph 26, all of which will be discussed in greater detail relation to FIG. 3. Data module 7 may be implemented in a number of different forms including data storage files, or as a database management system (DBMS). The database management system may be a relational (RDBMS), hierarchical (HDBMS), multidimensional (MDBMS), object oriented (ODBMS or OODBMS) or object relational (ORDBMS), or other database management system. Furthermore, although illustrated separately, data module 7 could be combined into a single database or other data storage structure. Data module 7 could, for example, be implemented as a single relational database (such as that marketed by Microsoft® Corporation under the trade designation “SQL SERVER”). One or more elements of data module 7 can also be implemented as software/hardware/firmware units that may be executed or otherwise implemented by computer processors 5, or have code that is loaded from memory 9/storage devices 11.

FIG. 3 is a block diagram illustrating one example of a communication between the central computing device and one of the computation nodes shown in FIG. 1, in accordance with one or more aspects of the present disclosure. In this example, central computing device 4 contains data module 7, as described above in the example of FIG. 2. Data module 7 includes a variety of data stores or data producing devices, including historical data 10, composite model 62, historical increments 12, codependence model 60, and computation graph 26. Historical data 10 is sent to composite model 62. Historical data 10 is used to calibrate each of the model parameters 14A and 14B. Calibrated model parameters 28 are sent from the composite model to the computation graph 26. The composite model also produces historical increments 12 during the calibration operation. Composite model 62 sends historical increments 12 to codependence model 60, where variance-covariance matrix 20 is calibrated. Variance-covariance matrix 20 is decomposed into a decomposed variance-covariance matrix. Transformation matrix 30 is then determined from the decomposed variance-covariance matrix. In one example, transformation matrix 30 is the decomposed variance-covariance matrix. In another example, the decomposed variance-covariance matrix is further transformed to produce transformation matrix 30. Transformation matrix 30 is then sent from codependence model 60 to computation graph 26. Computation graph 26 also contains random increment generator 22 and scenario indices 32. Computation graph 26 is sent from central computing device 4 to computation node 6A. Data module 25 of computation node 6A then produces scenario set 34A from the computation graph 26. Computation graph 26 is also sent from central computing device 4 to each computation node 6 displayed in FIG. 1, though only computation node 6A is shown in FIG. 3 for illustration purposes.

In software, the overall risk factor model is expressed as a composition of generators and accumulators. An accumulator is basically a state-full function object which maps one input type to another, but where the result will in general depend on the preceding sequence of mapping calls, thus producing a related sequence of results. After multiple mapping calls, a model accumulator can be reset( ) to its initial state and a new sequence of results can be produced, Repeated calls are made to the accumulator's mapping function updateState( ) each time passing in the increment η and the time interval Δt, and each time producing a set of risk factor values. This sequence of mapping calls thus produces the multi-time-step risk factor realizations of a single scenario; the accumulator can then be reset( )and the process repeated to produce additional scenarios for multiple sets of scenario indices. Codependence model 60 determines variance-covariance matrix 20 using historical increments 12. Codependence model 60 is also represented by an accumulator, even though it typically does not require the path-dependent behavior: its state is the variance-covariance matrix 20, and it accepts a sequence of uncorrelated values ξ to produce correlated increments for the marginal models 14A and 14B. A random increment generator 22 object is simply an object which produces a sequence of results.

Model accumulators can be linked together to produce new accumulators. Likewise, a random increment generator 22 can be linked to a model accumulator to produce anew generator, where the output from the composite generator is the accumulator-processed output from the original generator. Thus, the overall stochastic model for the evolution of ail risk factors can be encapsulated in a single composite generator.

Throughout this disclosure, a simple example has been focused on, but in general the network of accumulators describing the overall model is vastly more complex, especially for highly sophisticated risk factor models. Nevertheless, an aspect of this design is that, for both simple and complex models alike, the entirety of the risk factor model can be encapsulated in a single central computing device 4.

For example, in certain examples, given a variance-covariance matrix Ω, done is able to find a matrix A such that Ω=AÂT, then given a vector ξ of independent (i.e. uncorrelated) standard normal samples, the product Aξ, exhibits the same covariance relationship Ω. Thus, one is able to produce an arbitrary number of samples of correlated increments by simply producing sets of uncorrelated standard normal samples and multiplying them by the matrix A. In these examples, this process is called decomposing the variance-covariance matrix 20 in order to obtain a decomposed variance-covariance matrix. As stated above, in one example, the decomposed variance-covariance matrix is transformation matrix 30. In another example, the decomposed variance-covariance matrix can later be altered to form transformation matrix 30. For example, the variance-covariance matrix Ω could follow the formula Ω=AXÂT, where X is the square root of the variance-covariance matrix. In this example, transformation matrix 30 would equal the product of AX. Codependence model 60 collects statistics on these risk factor increment vectors in covariance matrix 20.

Random increment generator 22 produces uncorrelated random number increments 24, Random increment generator 22 can be a piece of program coded software. For example, random increment generator 22 may be a generator of N(0, 1) random increments and may produce a vector of uncorrelated random number increments 24 representing risk factor increments for a future scenario.

Historical data 10 could either be data input into the system or a series of measurements taken by the system over a certain amount of time. Historical data 10 is used to calibrate first model 14A and second model 14B. Before first model 14A and second model 14B can be used for generation, they must be provided with their required parameters {p₁, p₂, p₃, . . . }. These parameters may be directly specified from an outside source, e.g. by the user based on some desired scenario set properties, or from some external system where the parameters are calibrated. In many cases, the parameters can be calibrated from a sequence of historical observations 10; this can be done automatically using the composite model 62 representing the model 14A or 14B by essentially running the system in reverse. That is, one feeds historical observations into the marginal models where they are converted. to increments, which in turn are fed to the codependence model 60. Each model accumulates whatever statistics are required to estimate its parameters, and retains the parameter for use during scenario generation.

Computation graph 26 is generated from codependence model 60 and composite model 62 and contains random increment generator 22, calibrated model parameters 28, transformation matrix 30, and scenario indices 32. Transformation 30 is generated by decomposing the variance-covariance matrix 20 and further determining the transformation matrix from the decomposed variance-covariance matrix at codependence model 60. Calibrated model parameters 28 are generated by calibrating a sequence of historical observations 10; this can be done automatically using the composite model 62 representing the model 14A or 14B by essentially running the system in reverse. That is, one feeds historical data 10 into the first and second models 14A and 14B where they are converted to historical increments, which in turn are fed to the codependence model 60. Each model accumulates whatever statistics are required to estimate its parameters, and retains the parameter for use during scenario generation. Scenario indices 32 represent lists of scenarios that each computation node 6 will produce when computation graph 26 is sent to each computation node 6. Computation graph 26 is sent from central computing device 4 to computation node 6A upon completion of the calibration of computation graph 26.

Computation node 6A may be a workstation, server, mainframe computer, notebook or laptop computer, desktop computer, tablet, smartphone, feature phone, or other programmable data processing apparatus of any kind. Other possibilities for central computing device 4 are possible, including a computer having capabilities or formats other than or beyond those described herein.

In the illustrative example of FIG. 3, computation node 6A includes communications fabric 23B, computer processor 5B, memory unit 9B, storage device 11B, communications unit 19B, and input/output (I/O) unit 21B. Each of these units has a function and structure that is similar to the possible functions and structures in the corresponding unit of computing device 4 and described in FIG. 2.

Computation node 6A may also contain data module 25. Data module 25 may contain a variety of data stores or data producing devices, including computation graph 26 and scenario set 34A. Data module 25 may be implemented in a number of different forms including data storage files, or as a database management system (DBMS). The database management system may be a relational (RDBMS), hierarchical (HDBMS), multidimensional (MDBMS), object oriented (ODBMS or OODBMS) or object relational (ORDBMS), or other database management system. Furthermore, although illustrated separately, data module 25 could be combined into a single database or other data storage structure. Data module 25 could, for example, be implemented as a single relational database (such as that marketed by Microsoft® Corporation under the trade designation “SQL SERVER”). One or more elements of data module 25 can also be implemented as software/hardware/firmware units that may be executed or otherwise implemented by computer processors 5B, or have code that is loaded from memory 9B/storage devices 11B.

In certain non-limiting examples, computation node 6A generates scenario set 34A by decompressing the computation graph 26. In these examples, computation node 6A does this using a matrix-matrix algorithm that is based on single instruction multiple data (SIMD) instructions. These SIMD instructions could be SIMD-based multiplication algorithms available in chip-specific compilations of a math performance library (e.g., Intel MKL, IBM ESSL, Oracle SunPerf). The proposed scenario compression mechanism can be advantageous if the time required to transport the serialized model and decompress it to a traditional scenario set file will take less time that it would to generate and transport a scenario set of the desired size. This break-even point may be dependent on the number of simulation time acts and the desired number of scenarios. However, to ensure that the threshold where this tactic becomes advantageous is as low as possible, bulk matrix-matrix operations can be used instead of multiple matrix-vector operations.

The abstraction of the generator-accumulator interfaces means that, with minor modifications, various codependence models 60 can be modified such that they accept correlated increments 24 instead of uncorrelated increments. At the same time, the vector-generator of ξ can be replaced with a vector-generator of a matrix-product of the variance-covariance matrix A and ξ but where internally multiple Aξ products are calculated all at once in matrix-matrix form. The columns of the resulting matrix are returned in sequence, thus preserving all of the software infrastructure that relies on handling one vector or risk factor increments at a time.

In some examples, scenario set 34A is a three-dimensional matrix. The three data values used in this matrix is time data 36, scenario identification number 38, and risk factor value 40. The risk factor value 40 at a time t is a function of the risk factor's value at some previous time, the change in time from time t to that previous time, the increment from the given models, and zero or more additional parameters p₁, p₂, p₃, . . . . These additional parameters could be growth rates, mean reverting rates, mean reverting levels, to name only a few examples. Given the data in the computation graph 26, a risk factor value 40 at a time 36 for a given scenario 38 can be produced.

Scenario set 34A is produced at computation node 6A. Random increment generator 22 generates uncorrelated random increments 24. Uncorrelated random increments 24 are combined with transformation matrix 30 to compute correlated random increments. These correlated random increments are combined with the corresponding calibrated model parameters 28, depending on which scenario is to be produced as dictated by scenario indices 32. This combination forms a single scenario. This process is repeated for each scenario identification number in scenario indices 32 to form a plurality of scenarios, or scenario set 34A.

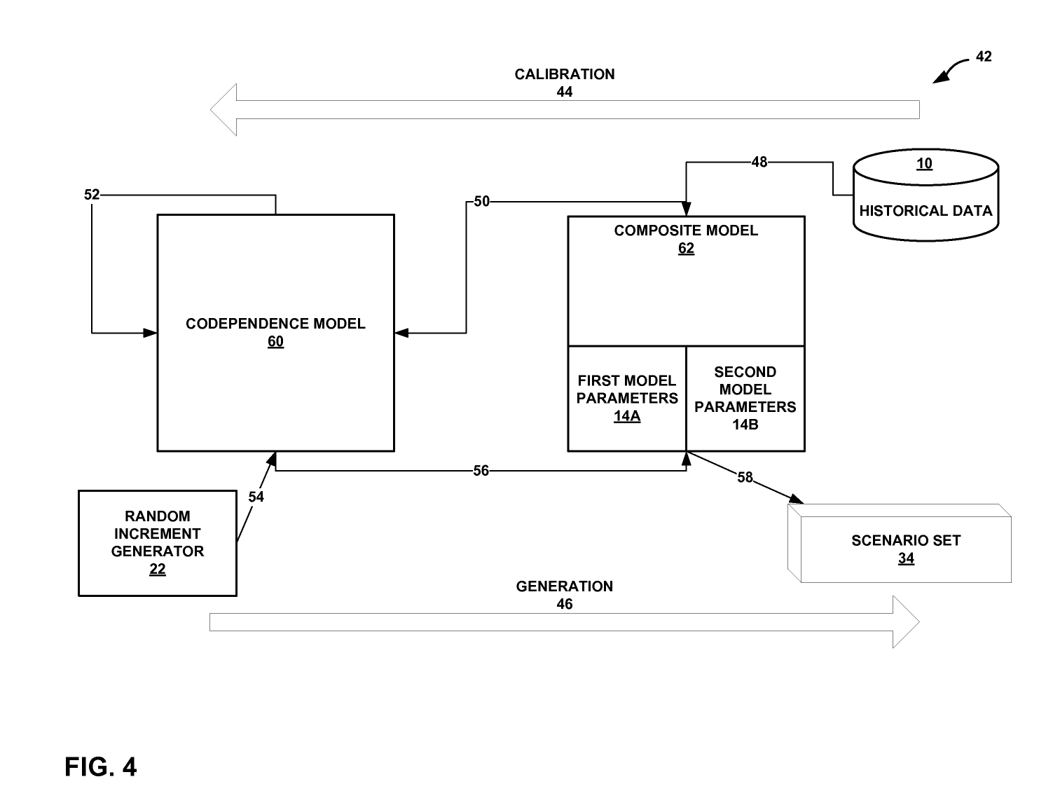

FIG. 4 is a block diagram illustrating an example of a generation of a scenario set, in accordance with one or more aspects of the present disclosure. In process 42, acts 48, 50, and 52 may be performed by a central computing device, such as central computing device 4 shown in any of FIGS. 1-3. Central computing device 4 sends historical data 10 to composite model 62, where statistical calibration of various model (and model combination) parameters, such as first model 14A and second model 4B, based on vector risk factor values, driven one at a time, per historical time-step, occurs (48). Historical data 10 comes from an up-to-date historical database.

Composite model 62 is a replacement of the scenario set as the embodiment of future risk factor evolution. As such, it encapsulates the true distribution described by the model, rather than an empirical sample of it. Thus, rather than sharing the scenario set with multiple instrument pricing nodes, a serialized representation of the model itself is shared. This representation is a companion of the original notion of a scenario set, as the serialized model may be much smaller in size than a scenario set for any reasonable number of scenarios. This represents a potentially asymptotically infinite compression scheme, since the problem has been expressed in a closed functional form.

This “functional-form file” can replace the notion of a “scenario set file” in any context, provided that a “decompression” library is available which converts the model file into the regular risk factor space, and that decompression can be done in a reasonable amount of time. Whether the decompression will occur on demand in real-time during instrument pricing, or whether it will take place once in order to create the standard scenario set file, may depend on the problem context.

First model 14A and second model 14B, which are marginal models, convert historical data 10 into historical increments, such as historical increments 12 in FIG. 3. Although only two models are depicted in FIG. 4, composite model 62 could have only one model or it could have more than two models. Increment calculation is model specific. The driven time-based increments are correlated based on a selected codependence model 60. Codependence model 60 produces a variance-covariance-like matrix/matrices expressing increment relationships (50). The root of this matrix is taken by central computing device 4 using decomposition, a very expensive, not scalable, and time-consuming operation requiring large memory footprint, and then the transformation matrix is determined from the resulting decomposed variance-covariance matrix, such as transformation matrix 30 in FIG. 3 (52). Acts 48, 50, and 52 comprise the calibration, or determining, acts 44 in the overall process 42. The transformation matrix, the calibrated model parameters, scenario indices, and random increment generator 22 are sent from central computing device 4 (of FIG. 1-3) to any of the computation nodes 6A-6N (of FIG. 1-3), where acts 54, 56, and 58 are performed.

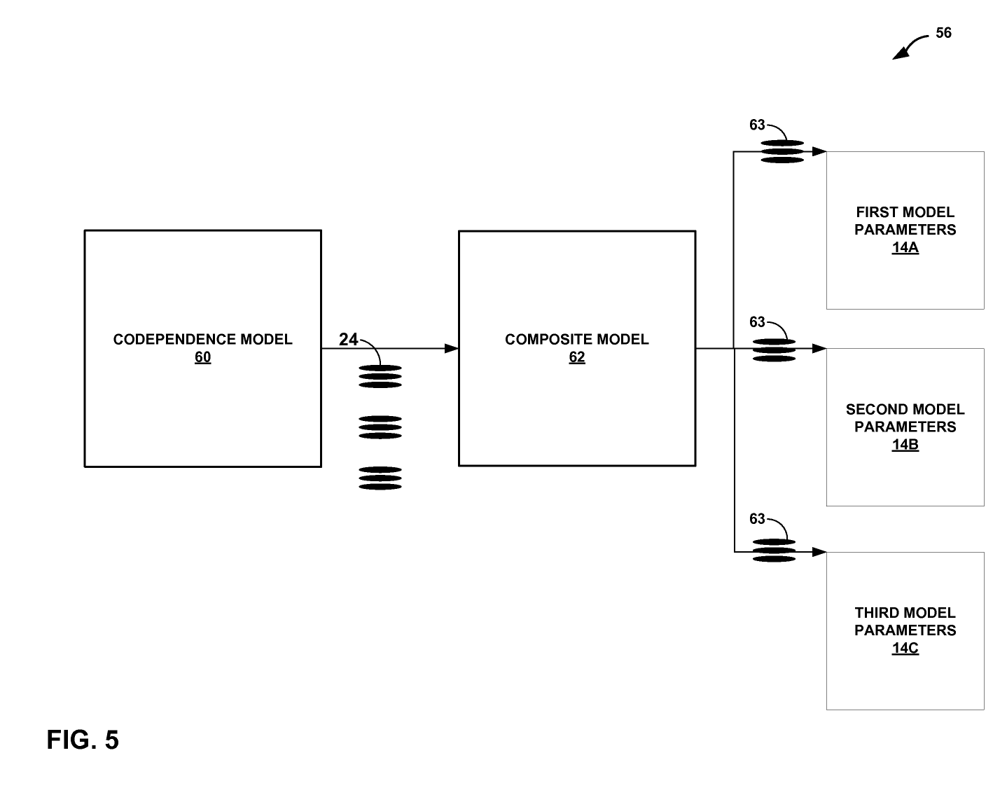

In sonic examples, a random increment generator 22 of N(0,1) random increments (or other) produces a vector of uncorrelated numbers representing risk factor increments for a future scenario, such as uncorrelated random increments 24 of FIG. 3 (54). The increments generated get correlated using the transformation matrix, producing correlated random increments (56). The correlated random increments are transformed by the calibrated model parameters into risk factor values, using the models/equations that were calibrated in act 48. The result is a vector of numbers that follow a set of predetermined mathematical models, and also a given historical correlation (58). This vector may be called a ‘scenario.’ Repeating acts 54, 56, and 58, or the generation phase 46, allows the production many of these, called a ‘scenario set’ 34. When the overall process 42 is used for simulation, the process 42 may first use the codependence model 60 to produce a vector of correlated values (see FIG. 5) that encapsulate the relationship between risk-factors.

FIG. 5 is a block diagram illustrating an example of a transformation act in the generation of the scenario set shown in FIG. 4, in accordance with one or more aspects of the present disclosure. FIG. 5, in other words, is amore detailed depiction of what occurs in act 56 of FIG. 4. Many risk factor models assume that the values that should be correlated are the returns of the risk factor rather than its current value; e.g., it is expected that the relative change in the US Dollar-Canadian Dollar exchange rate over the course of a day to have a correlation with the relative change in the US Dollar-Euro exchange rate during the same day, as opposed to there being a correlation between the absolute level of the respective exchange rates. Thus, it is the incremental changes in risk factors that are expected to be inter-dependent, and so we say that the codependence model is responsible for producing “correlated increments” for the overall model 42. The transformation matrix generated from codependence model is responsible for correlating the uncorrelated random increments 24 to produce correlated random increments 63. Correlated random increments 63 are combined with each of the model parameters 14A, 14B, and 14C, representing the calibrated model parameters (e.g., calibrated model parameters 28) to form a series of risk factor values, or a scenario.

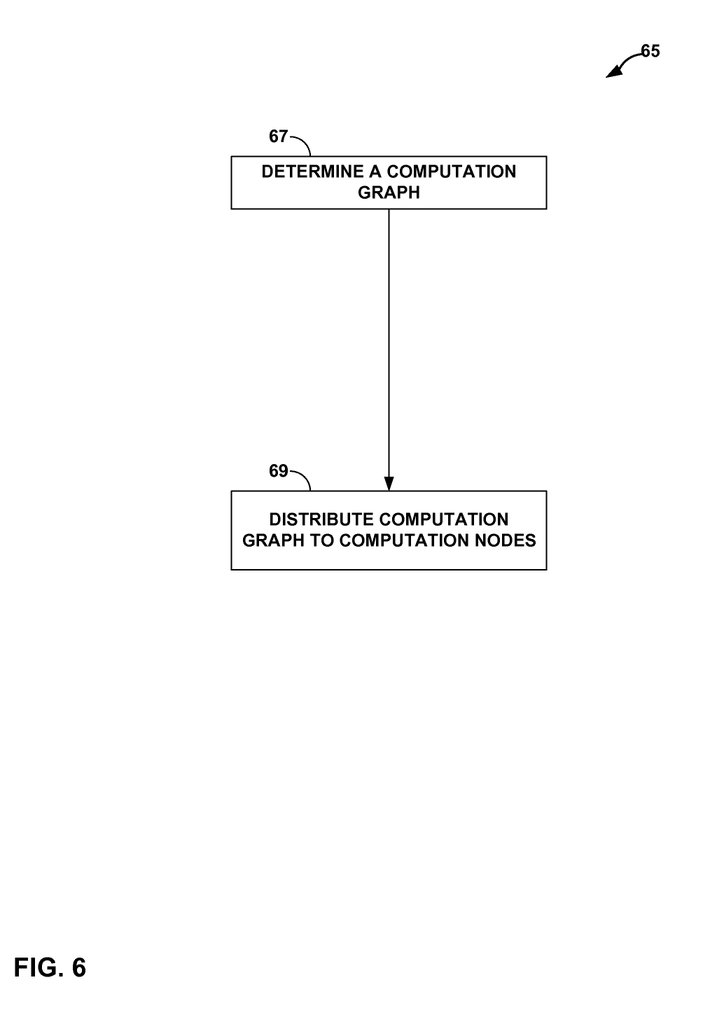

FIG. 6 is a flow diagram illustrating an example process 65 to generate scenario data, in accordance with one or more aspects of the present disclosure. Process 65 may be performed by a computing device, such as computing device 4 shown in FIGS. 1-3.

Here, at least one computer processor (e.g., at least one of computer processors 5) determines a computation graph (e.g., computation graph 26), wherein the computation graph comprises at least one of a group of scenario indices (e.g., scenario indices 32), a random increment generator (e.g., random increment generator 22), calibrated model parameters (e.g., calibrated model parameters 28), and a transformation matrix (e.g., matrix 30) (67). The at least one computer processor distributes the computation graph to one or more computation nodes (e.g., one or more of computation nodes 6A-6N) (69). Each computation node of the one or more computation nodes is configured to generate scenario data specific to the respective computation node based on the computation graph, and each computation node of the one or more computation nodes is configured to use the respective scenario data to measure risk in a financial system.

In some examples, each computation node of the one or more computation nodes generates its respective scenario data using a matrix-matrix multiplication algorithm based on the computation graph. In some examples, determining the computation graph at the computer processor further includes receiving parameters for at least one model, wherein the parameters are specified from an outside source, calibrating the parameters based on a sequence of historical observations of at least one risk factor, wherein calibrating the parameters comprises inputting data associated with the sequence of historical observations into each of the at least one models to produce historical increments, accumulating the historical increments on an inter-dependent relationship in a variance-covariance matrix at a codependence model, decomposing the variance-covariance matrix to generate a decomposed variance-covariance matrix, and determining the transformation matrix from the decomposed variance-covariance matrix.

In some examples, the computer processor of FIG. 6 is further configured to generate random number increments at the random increment generator to produce a vector of uncorrelated numbers representing risk factor increments for a future scenario, correlate the random number increments to produce correlated random number increments, transform the correlated random number increments into risk factor values using the transformation matrix, and combine the risk factor values with the calibrated model parameters to form the scenario data.

In some examples, the respective scenario data generated by each computation node of the one or more computation nodes includes a time data value, a scenario identification number that identifies a particular scenario representation, and a risk factor value, wherein the risk factor value is a function of at least a previous value of the risk factor value, a time interval since the previous value of the risk factor value was realized, and an increment from codependence model.

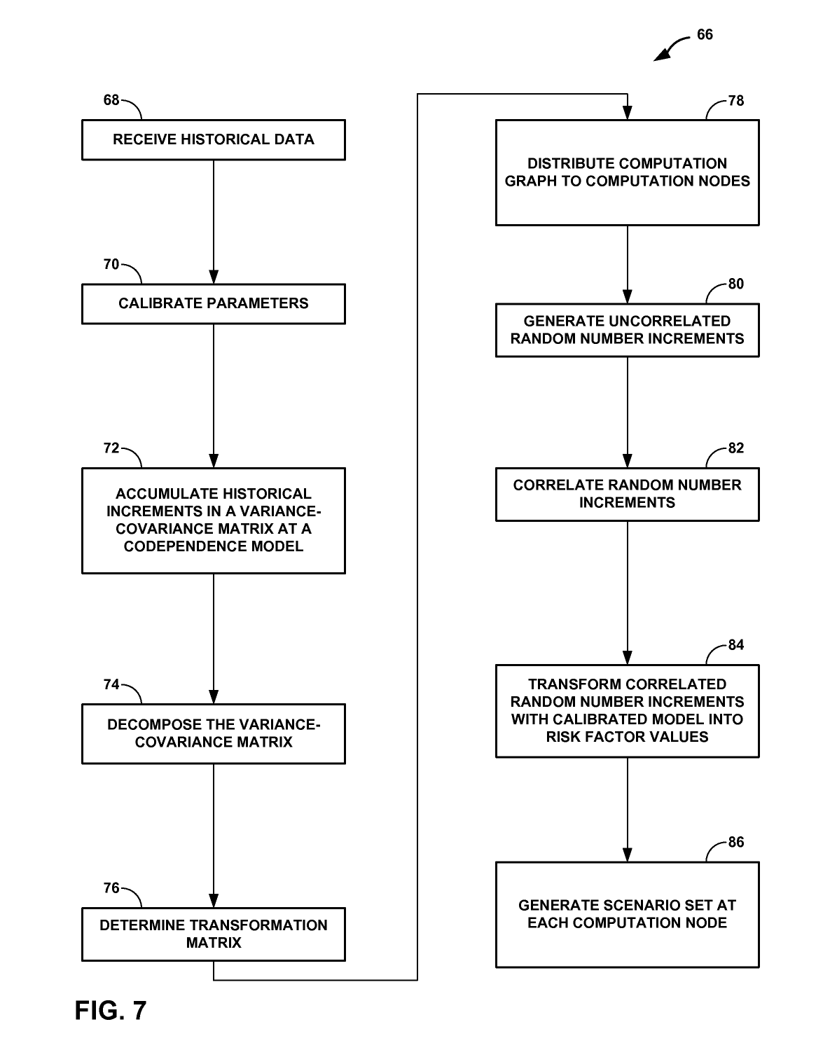

FIG. 7 is a flow diagram illustrating an example process 66 to calibrate and generate scenario data, in accordance with one or more aspects of the present disclosure. Process 66 may be performed by a computing device, such as computing device 4 shown in FIGS. 1-5.

The at least one computer processor (e.g., at least one computer processors 5) receives parameters for a first model and a second model (e.g., first model 14A and second model 14B), wherein the historical data (e.g. historical data 10) is received from an outside source (68). The computer processor calibrates the parameters based on the historical data, wherein calibrating the parameters comprises inputting data associated with the sequence of historical observations into at least one model (e.g., first and second models 14A and 14B) to produce historical increments (e.g., historical increments 12) to be input into the codependence model (e.g., codependence model 60) (70). The computer processor accumulates the historical increments on an inter-dependent relationship in a variance-covariance matrix (e.g., variance-covariance matrix 20) at the codependence model (72). The computer processor decomposes the variance-covariance matrix to generate a decomposed variance-covariance matrix (74). The computer processor determines a transformation matrix (e.g., transformation matrix 30) from the decomposed variance-covariance matrix (76). A random increment generator (e.g., random increment generator 22), the transformation matrix, the calibrated model parameters, and scenario indices (e.g., scenario indices 32), collectively a computation graph (e.g., computation graph 26), are distributed by the computer processor to one or more computation nodes (e.g., one or more of computation nodes 6A-6N) (78). The random increment generator generates uncorrelated random number increments (e.g., uncorrelated random number increments 24) (80). The computation node correlates the random number increments using the transformation matrix to produce correlated random number increments (82). The computation node transforms the correlated random number increments into risk factor values using the calibrated model parameters and based on the specific index in the scenario indices (84). Steps 80, 82, and 84 are then repeated, depending on the amount of instances in scenario indices to generate a scenario set (86). Each computation node of the one or more computation nodes is configured to use the respective scenario data to measure risk in a financial system.

As will be appreciated by a person skilled in the art, aspects of the present disclosure may be embodied as a method, a device, a system, or a computer program product, for example. Accordingly, aspects of the present disclosure may take the form of an entirety hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the computer processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, a system, apparatus, or device used to store data, but does not include a computer readable signal medium. Such system, apparatus, or device may be of a type that includes, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RE) or other wireless, wire line, optical fiber cable, etc., or any suitable combination of the foregoing. Computer program code for carrying out operations for aspects of the present invention may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present invention are described herein with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational acts to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1. A method, comprising:
determining, by at least one computer processor, a computation graph, wherein the computation graph comprises at least one of: a random increment generator, a transformation matrix, a group of scenario indices, and calibrated model parameters; and
distributing, by the at least one computer processor, the computation graph to one or more computation nodes, wherein each computation node of the one or more computation nodes is configured to generate scenario data specific to the respective computation node based on the computation graph, and wherein each computation node of the one or more computation nodes is configured to use the respective scenario data to measure risk in a financial system.

2. The method of claim 1, wherein each computation node of the one or more computation nodes generates its respective scenario data using a matrix-matrix multiplication algorithm based on the computation graph.

3. The method of claim 1, wherein determining the computation graph comprises:
receiving parameters for at least one model, wherein the parameters are specified from an outside source;
calibrating the parameters based on a sequence of historical observations of at least one risk factor, wherein calibrating the parameters comprises inputting data associated with the sequence of historical observations into each of the at least one models to produce historical increments;
accumulating the historical increments on an inter-dependent relationship in a variance-covariance matrix at a codependence model;
decomposing the variance-covariance matrix to generate a decomposed variance-covariance matrix; and
determining the transformation matrix from the decomposed variance-covariance matrix.

4. The method of claim 1, further comprising:
generating random number increments at the random increment generator to produce a vector of uncorrelated numbers representing risk factor increments for a future scenario;
correlating the random number increments to produce correlated random number increments;
transforming the correlated random number increments into risk factor values using the transformation matrix; and
combining the risk factor values with the calibrated model parameters to form the scenario data.

5. The method of claim 1, therein the respective scenario data generated by each computation node of the one or more computation nodes comprises:
a time data value;
a scenario identification number that identifies a particular scenario representation; and
a risk factor value, wherein the risk factor value is a function of at least a previous value of the risk factor value, a time interval since the previous value of the risk factor value was realized, and an increment from a codependence model.

6. A method, comprising:
receiving, by at least one computer processor and from a central computing device, a computation graph, wherein the computation graph comprises at least one of: a random increment generator, a transformation matrix, a group of scenario indices, and calibrated model parameters, and a transformation matrix and is determined by the central computing device; and
generating, by the at least one computer processor, scenario data based on the computation graph to measure risk in a financial system.

7. The method of claim 6, wherein generating the scenario data based on the computation graph comprises generating the scenario data using a matrix-matrix multiplication algorithm based on the computation graph.

8. The method of claim 6, wherein the scenario data comprises:
a time data value;
a scenario identification number that identifies a particular scenario representation; and
a risk factor value, wherein the risk factor value is a function of at least a previous value of the risk factor value, a time interval since the previous value of the risk factor value was realized, and an increment from a codependence model.

9. The method of claim 6, further comprising repeating the generating of the scenario data for multiple sets of scenario indices.
